(19) United States
(12) Patent Application Publication
(10) Pub. No.: US 2007/0254267 A1
(43) Pub. Date: Nov. 1, 2007

(54) Teaching Model for Enterprise Management

(75) Inventor: Guoqiang Wang, Shenzhen (CN)

Correspondence Address: HAMRE, SCHUMANN, MUELLER & LARSON, P.C., P.O. BOX 2902, MINNEAPOLIS, MN, 55402-0902, US

(73) Assignee: Xiying WANG, Shenzhen, Guangdong (CN)

(21) Appl. No.: 11/572,859

(22) PCT Filed: Jul. 11, 2005
(86) PCT No.: PCT/CN05/01015

§ 371 Date: Jan. 29, 2007

(30) Foreign Application Priority Data
Jul. 30, 2004 (CN) 200410050897.5

(51) Int. Cl. G09B 19/18

(52) U.S. Cl. 434/107

(57) ABSTRACT

A teaching model for enterprise operation includes a base defining a market system model, a production system and product development system module, a management module, a business system module, a planning system module, a strategic module, and an information module. The production system and product development system module, the management module, the business system module, the planning system module, the strategic module, and the information module are arranged in turn from bottom to top on the base.

### BACKGROUND OF THE INVENTION

1. Field of the Invention

The present invention generally relates to teaching models and more particularly to a teaching model for enterprise operation.

2. Background of the Invention

Conventionally, the enterprise management, marketing, purchase, finance, human resource, production, product development, plan, strategy and information are the theories and subjects independent from each other, the textbooks for them are the training books for the enterprise's leaders. During the one-century training method development, these teaching materials play a great pushing role in the enterprise development. However, with the development of the enterprise, the weaknesses of the traditional training materials appear, which main include the weak or restrictions in 8 aspects:

1. The traditional materials focus on various component elements inside the enterprise during the research on the enterprise, which include management, marketing, purchase, finance, human resource, production, product development, plan, strategy and information. All these researches are scattered, even isolated from the enterprise operation. Most of disclosed rules are the internal development rules inside the subject and disclose the comprehensive mutual relation among various elements. For the matrix, the relation number is 9×9=81, so it can not disclose the objective rule of the whole enterprise operation. Therefore, in the past, for most of introduction materials to the enterprise, the core content is to manage the whole of the enterprise, or use the marketing or strategy to generalize the whole enterprise operation, its bug is that the local concept is used to replace the whole concept and deviate from practical operation and practical operation of the enterprise. The description to the enterprise in these textbooks involves the convents from concept to concept, from reasoning to reasoning, from abstraction to abstraction, so the enterprise leaders who lead the enterprise for the whole life can not understand the operation rule of the enterprise.

2. The past textbooks can not disclose the basic rule for the enterprise operation and can not abstract the basic ideas which guide the enterprise operation (for enterprise operation). The ideas for the enterprise operation in the past textbooks only attempt to use an enterprise operation element to dominate other elements, further dominate the whole enterprise, so it leads to man-made “weakness” of the manufacturing enterprise.

3. The traditional textbooks focus on the internal research on the operation elements of the enterprise, so it is lack of the researches on the affiliation relation among various elements for the enterprise operation and can not distinguish the affiliation relation among various elements, although they can know what the enterprises should do, but they can not know the action sequence and restriction relation among various elements.

4. The textbook only focuses on the importance of the content in the books, offer the “instruction” for the leaders which requirement the enterprise to implement, and does not describe those work which are also important during the operation process of the enterprise and are required to implement. Therefore, when the enterprise leaders focus on the main attention to an element, possible other elements are “lack” of attention during the enterprise operation, because the “instructions” offered by the traditional textbook are the detailed “instructions” for the enterprise operation and are not a general “instructions”.

5. The textbook only describes how the enterprises do and does not discuss possible problems and operation level during the operation, so it makes the enterprise leaders lack of the judgement standards during the operation, so leaders are difficult to find the “weak” during the operation.

6. The past textbooks describes the enterprise operation from the angle of the enterprise management, enterprise operation and strategic decision, position the enterprise leaders at the enterprise managers, enterprise operators and strategic deciders. This method uses the detailed work to position the general work of the enterprise board chairman and general managers and leads to misguidance to the work of the enterprise's board chairman and general manager.

7. Although the past text books have a huge system and include various schools, they can not establish the complete theoretical system for the enterprise operation from the point of the enterprise operation. In the past enterprise's training teaching materials, there are no training materials which can dominate the whole enterprise, are from the ten elements inside the enterprise and are higher than the ten elements inside the enterprise. The traditional materials can not guide the whole enterprise operation.

8. The contribution of the traditional textbook to the enterprise is to direct the enterprise how to do and give no detailed steps.

### SUMMARY OF THE INVENTION

The present invention generally provides a teaching model for enterprise operation to overcome the restriction of the current technology, non-operability and abstraction, which proposes an intuitive and comprehensive teaching model for the enterprise operation which has successfully guide the operation and management of the enterprise.

One embodiment of the present invention provides a teaching model for enterprise operation, which includes a base defining a market system model, a production system and product development system module, a management module, a business system module, a planning system module, a strategic module, and an information module. The production system and product development system module, the management module, the business system module, the planning system module, the strategic module, and the information module are arranged in turn from bottom to top on the base.

The market system module includes a product sale module, a capital operation module, a material and technology purchase module and a human resource market module.

A concave is defined at the base center, and at least one ring step is formed at an internal wall of the concave, which divides the product sale module into a low-value sale level, a market value sale level, a high-value sale level and an ultra-value sale level from the concave bottom to the top; and divides the capital operation market module into a capital reduction level, a capital market value level, a capital high value level and a capital ultra-value level, and further divides the material and technology purchase module into a high-price purchase level, a market value purchase level, a low-price purchase level and a personalized purchase level; and also divides the human resource module into a high-price employment level, a market price employment level, an economic employment level and an ultra-value level; and the vertical height of each step of the capital operation module, material and technology purchase module, human resource module from the concave bottom to top represents a price level obstacle, a relation level obstacle, a brand level obstacle and an information level obstacle, the vertical step height of the product sale module represents the price level obstacle, the information level obstacle, the brand obstacle and the relation level obstacle in turn.

The base is a polygon, round desk or column, on the external edge of the base, the product sale module is symmetric to the material and technology purchase module; the capital operation module is symmetric to the human resource module.

The business system module includes 16 ribbons, which are overlapped to form “+” structure, one end of these ribbon respectively connected with the product sale market module, capital operation module, material and technology purchase module and human resource module of the at least one ring step to form a marketing system module, a purchase system module, a finance system module, a human resource system module, another end is connected with the above “+” center and is limited to the production system and product development system module, this production system and product development system module are supported on the management module.

The management module, ring step and business system module at least includes four levels; from the concave bottom to top, the management module includes an invalid management module, a valid management module, a high-efficiency management module and an innovative management module in turn, the marketing system module, purchase system module, finance system module, human resource system module and production system and product development system module of the business system module includes the four levels: an invalid level, a valid level, a high-efficiency level and an innovative level, corresponding to the management module.

The planning system module is a vertical column on the production system and product development system module, along the direction from the model top to the base, it is divided into a middle and long term plan, an annual plan and a job plan, on the four sides, the product sale module corresponds to the market marketing plan; the capital operation module corresponds to the capital operation plan, the material and technology purchase module corresponds to the material and technology purchase plan, and the human resource module corresponds to the human resource plan.

The strategic module is at the top of the planning module, which includes four levels, along the direction from the base to top, divided into a non-information backup module, a semi-information strategic module, a current information strategic module and a full-information strategic module; the strategic system is shown at the top of the strategic module, comprising a core strategy and an edge strategy; the core strategy includes 6 items, it surrounds the enterprise's culture idea strategy, based on the logic relation, it is expanded as follows from inside to outside in turn: a profiting mode strategy, a management elevation strategy, a product development strategy, a market area strategy and an enterprise scale strategy; the edge strategy includes four items: a market sale strategy, a capital operation strategy, a material and technology purchase strategy and a human resource strategy, they are located around the core strategy, wherein the market sale strategy corresponds to the product sale market module on the top and bottom of same side, the capital operation strategy corresponds to the capital operation market on the top and bottom of same side, the material and technology purchase strategy corresponds to the material and technology purchase market module on the top and bottom of same side, the human resource strategy corresponds to the human resource market module on the top and bottom of same side.

The information module includes four parts: a reverse quadrangle cone at the top of the strategic module, wherein the four sides of the cone respectively represents a sale information processing, a fund information processing, a material and technology processing and a talent information processing of the market system module; at the top of the four market modules, there is a ribbon connecting the cone upwards and represents that the information directly get market information from the market system module, at the planning module center, the core solid column of the solid column penetrating through the bottom of the management module and top of the information cone represents the information system inside the enterprise, it indicates that all systems inside the system feed back the internal information to the information center; the solid column at the top of the cone represents the information assessing and information disclosure system based on the information inside the enterprise, the four sides of the vertical column respectively represents the enterprise's product competition, capital competition, material and technology purchase competition and human competition, the peak of the vertical column represents the enterprise's core competition.

The teaching model for enterprise operation shows a pyramid shape on the whole, along the direction form the model bottom to the top, each level of the management module is overlapped to form the pyramid type, each level of the described strategic module is overlapped as the reverse pyramid shape; each level of the management module and strategic module is the quadrangle, cylinder or round desk, the column of the planning system module and the column of the information assessing and information disclosure system are the cuboid and the core column representing the enterprise's internal information system is the cylinder.

Based on the 11 abstract elements for the enterprise operation (market, management, sale, purchase, finance, human resource, production, product development, plan, strategic and information), the beneficial effects of this invention are as follows: use solid and visual model technology to give the intuitive array and solid combination maximizing the value, disclose the necessary relation among elements such as mutual action and restriction, as well as the different levels and causality for the enterprise operation, so the model visually demonstrates the basic rule of the enterprise operation. This model is used as the teaching tool for the enterprise operation, enables the enterprise leaders to view the enterprise independently, visually appreciates the rule of the enterprise operation, abstracts the enterprise idea through the solid model and can be used as a tool for the enterprise operation to improve the capability for the enterprise operation.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 illustrates an exemplary teaching model for enterprise operation in accordance with the present invention;

FIGS. 2 is a part of the exemplary teaching model for enterprise operation in accordance with the present invention;

FIGS. 3 is another part of the exemplary teaching model for enterprise operation in accordance with the present invention.

### DETAILED DESCRIPTION

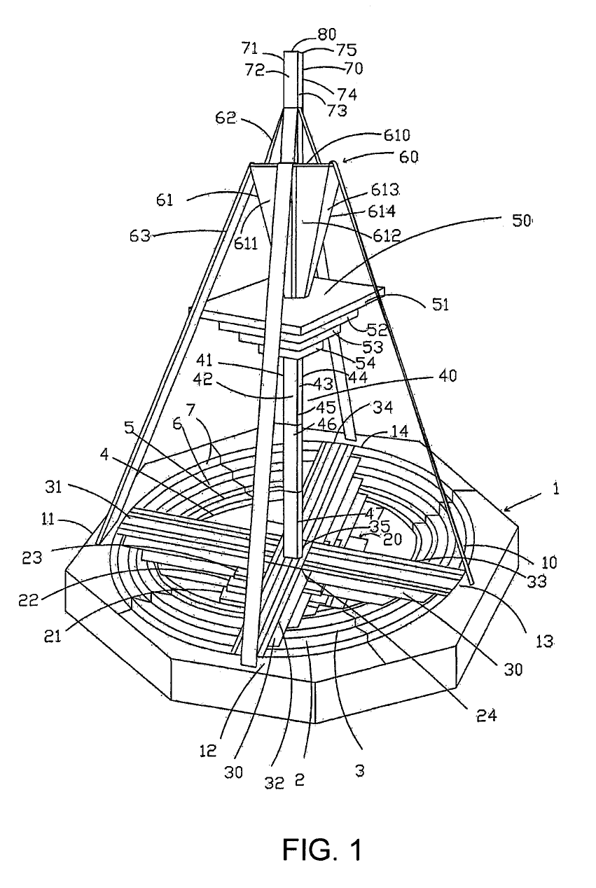

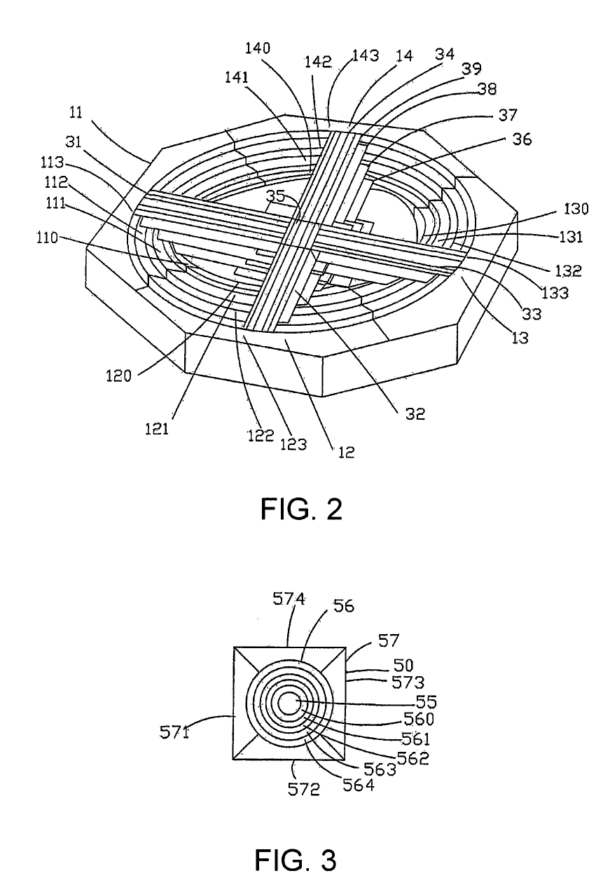

Referring to FIG. 1 and FIG. 2, a teaching model for enterprise operation 100 in accordance with the present invention shows the pyramid shape with the symmetric four edges. The teaching model for enterprise operation 100 comprises a base 1, a management module 20, a business system module 30, a planning system module 40, a strategic module 50, an information module 60 and a core competition module 75 from the bottom to the top. The teaching model for enterprise operation 100 is penetrated by a vertical axis 80 and shows the pyramid shape.

A market system module 10 is defined by the periphery of the base 1. The market system module 10 is divided into a product sale module 11, a capital operation module 12, a material and technology purchase module 13 and a human resource module 14. In this preferred embodiment, the base 1 is a column with an octagonal section, the product sale module 11, the capital operation module 12, the material and technology purchase module 13, the human resource module 14 are respectively distributed on each edge of the octagonal column, they are separated by the edge between them, and their centers are symmetric to each other, namely the product sale module 11 is symmetric to the center of the material and technology purchase module 13, the capital operation module 12 is symmetric to the center of the human resource module 14.

The base may be a polygon, round desk or column, on the external edge of the base, the product sale module is symmetric to the material and technology purchase module; the capital operation module is symmetric to the human resource module.

A concave 2 is formed on the center of the base 1. A ring step 3 is formed in an inside wall of the concave 2. The ring step 3 is divided into four layers, from the bottom of the concave 2 to top. The ring step 3 divides the product sale market module 11 as a low-value market level 110, a market value sale level 111, a high-value sale level 112 and an ultra-value sale layer 113. The ring step 3 also divides the capital operation module 12 into a capital value-decrease level 120, a capital market value level 121, a capital high-value level 122, a capital ultra-value level 132, and a personalized purchase level 133. Furthermore, the ring step 3 divides the human resource module 14 into a high-value employment level 140, a market value employment level 141, an economic employment 142 and an ultra-value employment level 143. The bottom of the concave 2 is upward, for the capital operation market module 12, the material and technology purchase module 13 and the human resource module 14, the vertical height of various steps represent a price level block 4, a relation level block, a brand level block 6 and an information level block 7 in turn. For the product sale market module 11, the vertical height of the step represents the price level block 4, the information level block 5, the brand level block 6 and the relation block 7 in turn. All these blocks are for the enterprise operation, if the enterprise operation spans a block, it will ascend to a new step.

The level 110-113, 120-123,130-133 and 140-143 of the four modules 11-14 of the market system module 10 corresponds to the described block 4-7 level in the horizontal direction, so based on the stage of the market system during the enterprise operation, you can find the block reasons for the development form the model in this invention intuitively. The market is seen as the external element and external conditions for the enterprise operation, it is seen as the external environment of the base 1 of the sold module 100 and enterprise elements to represent the market objectively, it is not determined by the enterprise's will, the enterprise operation must conform to the market operation rules.

The management module 20 is formed through overlapping of the cuboid which gradually becomes smaller from the bottom center of the concave 2 of the base 1 upward. The management module 20 is divided into four levels, which are an invalid manage module 21, a valid management module 22, a high-efficiency management 23 and an innovative management module 24 from the center of the base 1 to top, all levels of the management module 20 respectively correspond to the ring step 3 in the concave 2 of the above-mentioned base 1, which indicates that the management level corresponds to the level of the market system. In this embodiment, the height of component modules of the management module 20 is same to the step 3. The above-mentioned management module 20 is under the bottom of the business module 30 and production system and product development system module 35, which indicates that the management is the foundation of the business and production, the management level determines the business level and production level. Each level of the management module 21-24 respectively sets the business system module 30 with four “+” marks and two product system and product development system module 35, it represents that the management serves for the business and production and development.

The above business system module 30 comprises the 16 up and down parallel bands, they are overlapped to form the “+” shape consisting of four levels, the module level 21-24 of the management module 20 sets four crossed business system modules, the business system module 30 is combined with the product sale module 11, the capital operation module 12, the material and technology purchase module 13, human resource module 14 to form the four areas: an marketing system module 31, an financial system module 32, an purchase system module 33, and an human resource system module 34. The crossing center of the described four areas forms the described production system and product development system module 35, these five areas are selected by the enterprise to establish the profiting mode, including strengths of each area (including market strengths, resource strengths and capability strengths), which area is dominated, so the enterprise can cultivate the core competition and establish the profiting mode of the enterprise.

The described area 31-35 corresponds to the management module 20 and respectively represents the four levels with the different business levels: an invalid business level 36 for invalid management, a valid business level 37, a high-efficiency business level 38 and an innovative business level 39, one end of the described levels is connected to the four-level step of the four market module 11-14, it shows that the four market steps are the results of the four business levels. Another end of the up and down four level of this banded module is connected the four-level production system and product development system module 35 at the center of the mark “+”. Its bottom is connected with the management module 20 and its top is connected to the planning module, it indicates that the business level is directly associated with the market block, and with the production, development, management and planning level. The level 36-39 of the described business system module 30, the level 21-24 of the management module 20 and four modes of the market system module 10 correspond to the level 110-113/120-123/130-133/140-143 of the module 11-14 in the horizontal direction.

Each ribbon of the business system module 30 and the production system and product development system module 35 includes five different color ribbons, which represent that each business module 30 and production system and product development system consist of five elements. Five different ribbons represent five different elements, it includes two purposes:

1. It represents the work of each module, the obtained enterprise supporting items should not exceed the five listed items, these five supported items are from the following supported directions in the invention model: the back, left and right (person, finance and material), bottom (management) and top (planning).

2. Second purpose is to facilitate the diagnosis for the enterprise operation. Once one module of the sale, production (development), purchase, finance and human resource can not fulfill the planned index, this module should be checked whether to encounter a problem. Because this module comprises five elements, the most intuitive and simple diagnosis method is the elimination method, first those normal elements are eliminated, the problem element can be found. Once the problem element is found, the reason should be diagnosed. The most intuitive and simple method is the tracing method, you can track back the reason in accordance with the same color, the direct reasons include back, left and right party (person, finance and material), bottom(management) and top (plan) reason, for the indirect reason, you can trace back to the strategy and information.

The described planning system module 40 shows the vertical column shape, on the four sides, the corresponding side of the product sale module 11 is the market sale plan 41; the corresponding side of the capital operation module 12 is the capital operation plan 42; the corresponding side of the material and technology purchase module 13 is the material and technology purchase plan 43; the corresponding side of the human resource module 14 is the human resource plan 44. The planning system module 40 is at the top of the business system module 30, production system and product development system module 35 and the management module 20 and represents the work scheme of the enterprise management, marketing, purchase, finance, human resource, production and product development, they are guided and restricted by the plan. The bottom of the planning system module 40 is connected with the production system and product development system module 35, the top is connected with the strategic module 50, and the strategic module 50 is divided into a middle and long term planning module 45, an annual planning module 46 and a job planning module 47 in the direction of the production system and product development system module 35.

The strategic module 50 shows the reverse pyramid shape which is overlapped by the four cuboids gradually becoming larger from bottom to top, its position is between the information module 60 and the planning system module 40, and from top to bottom in vertical direction of the information module 60 and the planning system module 40, it is divided into a whole information strategic module 51, a current-information strategic module 52, a semi-strategic module 53 and a non-strategic strategic module 54, they represent the strategic level of different layers, the module content shows that information level must be improved for improvement of strategic level. Please also refer to the FIG. 3 for details, the described strategic module 50 shows the strategic system comprising a core strategy 56 an edge strategy 57, the core strategy includes 6 items and surround an enterprise culture (idea) strategy 55, based on the logic relation, the strategies are expanded from interior to outside in turn as follows: a profiting module strategy mode strategy 560, a management improving strategy 561, a product development strategy 562, a market area strategy 563 and an enterprise scale strategy 564; the edge strategy 57 comprises four items, they are respectively located at the surrounding of the core strategy 56: the product sale market module 11 corresponds to the market sale strategy 571 on the top and bottom of the same side, the capital operation market module 12 corresponds to the capital operation strategy 573 on the top and bottom of the same side, the material and technology purchase market module 13 corresponds to the material and technology purchase strategy 573 on the top and bottom of the same side, the human resource market module 14 corresponds to the human resource strategy 574 on the top and bottom of the same side. The strategy module 50 discloses three strategic roles: (1) the core strategy 56 guides the whole enterprise; (2) the edge strategy 57 guides the four operation work and orients to four markets; (3) the strategy is the foundation of the plan, the plan is converted into the strategy.

The described information module 60 comprises four parts: one is a reverse quadrangle cone 61 set at the top of the strategic module 50, it represents the process form the rough to fine. The four sides of the cone 61 respectively represents a sale information processing 611, a fund information processing 612, a material and technology information processing 613 and a talent information processing 614 from the four system modules 11-14. A band 63 connecting the cone 61 is at the top of the four market modules 11-14 and represents that the information system directly gets the information from four markets 11-14; at the center of the planning module, the core solid column 80 at the center of the cuboid vertical column 70 which penetrates the bottom of the management module 20 and top of the information cone 61 represents the information system inside the enterprise, each system inside the enterprise will feed the internal information back to an information center 610, a cuboid vertical column 70 at the top of the cone 61 represents information assessing and information disclosure system of the enterprise based on the information, the four sides of the vertical column respectively represents a product competition 71 of the enterprise, a capital competition 72, a material and technology purchase competition 73 and a human competition 74 at the top of the vertical column 70, namely the peak of this model, represents the core competition of an enterprise (namely profiting capability) 75, it is the fundamental aim for the enterprise operation.

The peak of the cone 61 of the described information module 60 is connected with the enterprise culture idea strategy 55 of the strategic module 50 and represents that only the idea of the enterprise leaders at the high level can understand the information and prepare for and adjust the strategy according to the information.

The “+” horizontal line in the described module 100, namely the ribbon connecting the material and technology purchase market 13 with product sale market 11, is the main flow for the enterprise operation-supply, production and sale flow. The described “+” vertical line, namely ribbon connecting the capital operation market 12 with the human resource market 14, is the auxiliary flow for the enterprise operation—finance flow and human resource flow. The management flow at the bottom of the “+” center is the fundamental flow of the main and auxiliary flow; the planning flow, strategic flow and information at the top of the “+” center is the guiding flow of the main and auxiliary flow.

When the enterprise manager uses the teaching module 100 in this invention, first, the external market information is directly reflected by the four sub-system 11-14 of the market system module 10 represented by the surrounding of the base 1 and respectively input the product sale site information, capital market information, material and technology market information and human resource market information to the information center 610 of the information module 60 through four titled ribbon 63 connecting the market system module 10 with the information module 10, meanwhile, the internal information during the enterprise operation is inputted to the information center 610 of the cone 61 through the four tilted ribbon 62 at the top of the cone 61 of the information module 60, next, the information is processed in accordance with the category of the four side 611-614 of the cone 61 and is inputted to the enterprise culture idea strategy 55 of the strategic module 50 center from the peak of the reverse cone 61, through the enterprise culture idea, on the one hand, the center strategy 56 and edge strategy 57 of the enterprise is prepared based on the inputted market information, the plan is prepared based on the enterprise's strategy, it shows in the model 100 of the invention that the overlapped reverse pyramid strategic module 50 is vertically connected with the planning system module 40 downward; the prepared plan fist is middle and long term plan (represented by the middle and long term planning module 45), second plan is the detailed job plan (represented by the job planning module 47), the described plan includes the market sale, capital operation, material and technology purchase, and human resource plan, the job plan is inputted to the production system and product development system (represented by the production system and product development system module 35 at the center of the business system module 30 ribbon), and then configure and use the enterprise resource and realize the operation.

During the business and management of the enterprise, the strategic level (full information strategy, current information strategy, semi-information strategy and non-information strategy), management level (innovative management, high-efficiency management, valid management, or invalid management) determine the operation situation of the enterprise (innovative operation, high-efficiency operation, valid operation and invalid operation), it is intuitively reflected from the model 100 of this invention. The details are as follows, the strategic module 50 is divided into the full-information strategic module 51, current information strategic module 52, semi-information strategic module 53, non-information strategic 54 from top to bottom, the management module 20 is divided into the innovative management module 24, high-efficiency management module 23, valid management module 22 and invalid management module 21 from top to bottom. The business system module 30 is divided into the innovative business level 39, high efficiency business level 38, valid business level 37 and invalid business level 36, you can find each level for the enterprise operation from the model 100 in this invention. The obstacles from the low level to high level include the price level obstacle level 4, relation level obstacle 5, brand obstacle 6 and information obstacle 7.

We claim:

1. A teaching model for enterprise operation, comprising:
a base, said base defining a market system model,
a production system and product development system module,
a management module,
a business system module,
a planning system module,
a strategic module, and
an information module,
wherein the production system and product development system module, the management module, the business system module, the planning system module, the strategic module, and the information module are arranged in turn from bottom to top on the base.

2. The teaching model for enterprise operation of claim 1, wherein the market system module comprises a product sale module, a capital operation module, a material and technology purchase module and a human resource market module.

3. The teaching model for enterprise operation of claim 2, wherein a concave is defined at the base center, and at least one ring step is formed at an internal wall of the concave, which divides the product sale module into a low-value sale level, a market value sale level, a high-value sale level and an ultra-value sale level from the concave bottom to the top; and divides the capital operation market module into a capital reduction level, a capital market value level, a capital high value level and a capital ultra-value level, and further divides the material and technology purchase module into a high-price purchase level, a market value purchase level, a low-price purchase level and a personalized purchase level; and also divides the human resource module into a high-price employment level, a market price employment level, an economic employment level and an ultra-value level; and the vertical height of each step of the capital operation module, material and technology purchase module, human resource module from the concave bottom to top represents a price level obstacle, a relation level obstacle, a brand level obstacle and an information level obstacle, the vertical step height of the product sale module represents the price level obstacle, the information level obstacle, the brand obstacle and the relation level obstacle in turn.

4. The teaching model for enterprise operation of claim 3, wherein the base is a polygon, round desk or column, on the external edge of the base, said product sale module is symmetric to the material and technology purchase module; the capital operation module is symmetric to the human resource module.

5. The teaching model for enterprise operation of claim 4, wherein the business system module comprises 16 ribbons, which are overlapped to form “+” structure, one end of these ribbon respectively connected with the product sale market module, capital operation module, material and technology purchase module and human resource module of said at least one ring step to form a marketing system module, a purchase system module, a finance system module, a human resource system module, another end is connected with the above “+” center and is limited to said production system and product development system module, this production system and product development system module are supported on said management module.

6. The teaching model for enterprise operation of claim 5, wherein said management module, ring step and business system module at least comprises four levels; from the concave bottom to top, the management module includes an invalid management module, a valid management module, a high-efficiency management module and an innovative management module in turn, the marketing system module, purchase system module, finance system module, human resource system module and production system and product development system module of the business system module comprises the four levels: an invalid level, a valid level, a high-efficiency level and an innovative level, corresponding to the management module.

7. The teaching model for enterprise operation of claim 2, wherein said planning system module is a vertical column on the production system and product development system module, along the direction from the model top to the base, it is divided into a middle and long term plan, an annual plan and a job plan, on the four sides, the product sale module corresponds to the market marketing plan; the capital operation module corresponds to the capital operation plan, the material and technology purchase module corresponds to the material and technology purchase plan, and the human resource module corresponds to the human resource plan.

8. The teaching model for enterprise operation of claim 2, wherein said strategic module is at the top of the planning module, which comprises four levels, along the direction from the base to top, divided into a non-information backup module, a semi-information strategic module, a current information strategic module and a full-information strategic module; the strategic system is shown at the top of said strategic module, comprising a core strategy and an edge strategy; the core strategy includes 6 items, it surrounds the enterprise's culture idea strategy, based on the logic relation, it is expanded as follows from inside to outside in turn: a profiting mode strategy, a management elevation strategy, a product development strategy, a market area strategy and an enterprise scale strategy; the edge strategy comprises four items: a market sale strategy, a capital operation strategy, a material and technology purchase strategy and a human resource strategy, they are located around the core strategy, wherein said market sale strategy corresponds to the product sale market module on the top and bottom of same side, the capital operation strategy corresponds to the capital operation market on the top and bottom of same side, the material and technology purchase strategy corresponds to the material and technology purchase market module on the top and bottom of same side, the human resource strategy corresponds to the human resource market module on the top and bottom of same side.

9. The teaching model for enterprise operation of claim 2, wherein said information module comprises four parts: a reverse quadrangle cone at the top of the strategic module, wherein the four sides of the cone respectively represents a sale information processing, a fund information processing, a material and technology processing and a talent information processing of the market system module; at the top of the four market modules, there is a ribbon connecting the cone upwards and represents that the information directly get market information from the market system module, at the planning module center, the core solid column of the solid column penetrating through the bottom of the management module and top of the information cone represents the information system inside the enterprise, it indicates that all systems inside the system feed back the internal information to the information center; the solid column at the top of the cone represents the information assessing and information disclosure system based on the information inside the enterprise, the four sides of the vertical column respectively represents the enterprise's product competition, capital competition, material and technology purchase competition and human competition, the peak of the vertical column represents the enterprise's core competition.

10. The teaching model for enterprise operation of claim 1, wherein the teaching model for enterprise operation shows a pyramid shape on the whole, along the direction form the model bottom to the top, each level of said management module is overlapped to form the pyramid type, each level of the described strategic module is overlapped as the reverse pyramid shape; each level of said management module and strategic module is the quadrangle, cylinder or round desk, the column of said planning system module and the column of the information assessing and information disclosure system are the cuboid and the core column representing the enterprise's internal information system is the cylinder.
